(19) United States
(12) Patent Application Publication
(10) Pub. No.: US 2009/0324228 A1
(43) Pub. Date: Dec. 31, 2009

(54) ONT TEST UNIT

(75) Inventors: Marc R. Bernard, Miramar, CA (US); Thomas E. Conklin, Leesburg, VA (US); John A. Stock, Leesburg, VA (US); Joseph D. Kralowetz, Clarksville, MD (US)

Correspondence Address: FITZPATRICK CELLA HARPER & SCINTO, 1290 Avenue of the Americas, NEW YORK, NY, 10104-3800, US

(73) Assignee: Tellabs Petaluma, Inc., Naperville, IL (US)

(21) Appl. No.: 12/165,576

(22) Filed: Jun. 30, 2008

(51) Int. Cl. H04J 14/02

(52) U.S. Cl. 398/79

(57) ABSTRACT

An Optical Network Terminal (ONT) simulator is provided. The ONT simulator includes one or more partially functional ONTs coupled to an Optical Line Termination (OLT) and an ONT/Optical network termination Management and Control Interface (ONT/OMCI) simulation utility. The ONTs receive test network traffic from the OLT and forward any OMCI traffic contained in the network traffic to the ONT/OMCI simulation utility. The ONT/OMCI simulation utility in turn simulates the operation of field-deployable ONT using the OMCI traffic.

### BACKGROUND

1. Field

Example aspects of the invention relate generally to testing components of optical networks, and more particularly to testing Optical Network Terminals (ONTs).

2. Related Art

Passive Optical Network (PON) systems enable up to 32 (and sometimes more) Optical Network Terminals (ONTs) to be used in a system. In order to use multiple ONTs, a significant amount of Optical Line Termination (OLT) and ONT interoperability is required. Therefore, it is desirable to test ONTs in an environment where multiple ONTs are connected to an OLT in order to ensure interoperability within a system that is as close to conditions in an actual system deployed in the field. Test lab systems are designed to provide testers and developers with either a single ONT or multiple ONTs that are mounted in a rack within a test lab's systems. These ONTs require a significant amount of space. Furthermore, when new generation ONTs are available, the test labs must be upgraded to support the new ONTs. This requires a significant amount of time and effort to replace these units as well as money to pay for labor and equipment purchase and disposal costs.

### BRIEF DESCRIPTION

The foregoing can be addressed with a method, apparatus, system, and computer program that provide a multiple ONT test solution that promotes effectiveness and efficiency in testing, integration and interoperability.

In one example embodiment of the invention, an ONT simulator and/or enclosure enables vendors to use the ONT simulator as a mobile test unit or testing station. This enables a group of test labs or specific test environments to easily use any ONT supplier's Optical network termination Management and Control Interface (OMCI) stack. The ONT simulator ensures that all packages are the same and that an installed OLT does not cause any problems during the provisioning process. Furthermore, the ONT simulator provides a test bed for testing of interoperability programs before actually testing vendors' physical units. This makes it much easier to diagnose interoperability problems.

In another example embodiment of the invention, an ONT simulator includes an ONT having a Wave Division Multiplexer (WDM) coupled to a simulator host via a communications port. The simulator host hosts an ONT/Optical network termination Management and Control Interface (ONT/OMCI) simulation utility.

In another example embodiment of the invention, the ONT includes a plurality of WDMs, each with their own MAC controller. Each of the WDMs in the plurality of WDMs communicates via the MAC controller and communications port with the ONT/OMCI simulation utility.

In another example embodiment of the invention, the ONT further includes an Application Programming Interface (API).

In another example embodiment of the invention, an ONT/OLT interface is coupled between the ONT simulator and an OLT.

### BRIEF DESCRIPTION OF THE DRAWINGS

FIG. 1 is a block diagram of a single ONT simulator in accordance with an example embodiment of the invention.

FIG. 2 is a sequence diagram of communications between an ONT simulator and an OLT in accordance with an example embodiment of the invention.

FIG. 3 is a block diagram of a multi-ONT simulator in accordance with an example embodiment of the invention.

FIG. 4 is a sequence diagram of communications between an OLT and a multi-ONT simulator in accordance with an example embodiment of the invention.

FIG. 5 is a block diagram of a multi-ONT having additional Media Access Control logic in accordance with an example embodiment of the invention.

FIG. 6 is a block diagram of a multi-ONT having an Application Programming Interface in accordance with an example embodiment of the invention.

FIG. 7 is a collaboration diagram of an end-to-end ONT simulator with a Graphical User Interface in accordance with an example embodiment of the invention.

FIG. 8 is a perspective view of a multi-ONT system composed of individual ONTs packaged in a rack mount in accordance with an example embodiment of the invention.

FIG. 9 is a block diagram of an ONT simulator including an additional device that adds additional features to the ONT simulator in accordance with an example embodiment of the invention.

FIG. 10 is a process flow diagram of an automated test sequence and report generation process as executed by an ONT simulator in accordance with an example embodiment of the invention.

FIG. 11 is a sequence diagram of communications between an OLT and a multi-ONT simulator simulating a rogue ONT in accordance with an example embodiment of the invention.

Identically labeled elements appearing in different ones of the figures refer to the same elements but may not be referenced in the description for all figures.

### DETAILED DESCRIPTION

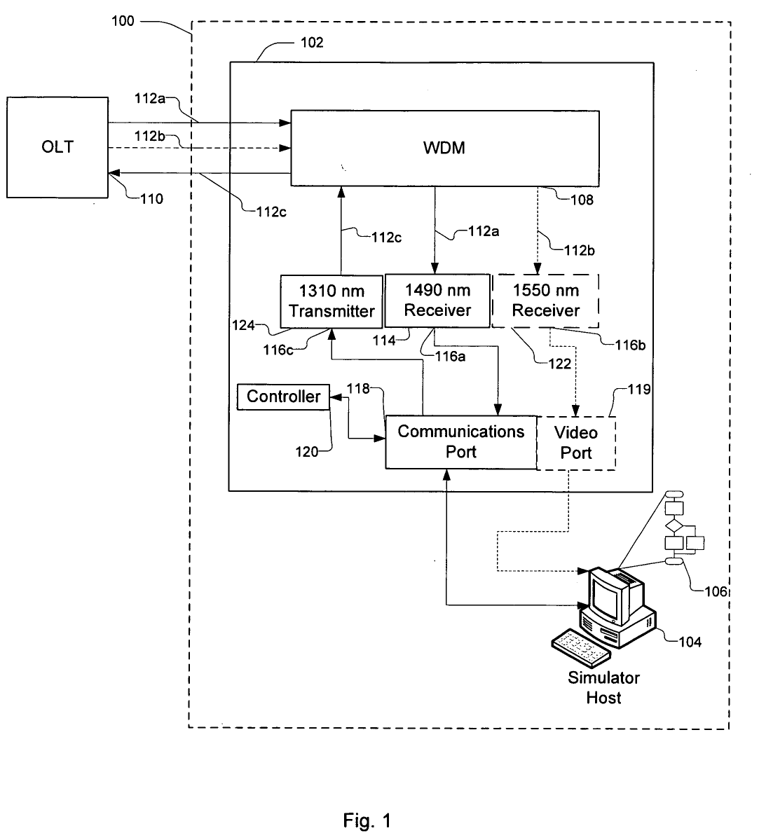

FIG. 1 is a block diagram of a single ONT simulator 100 coupled to an OLT 110 in accordance with an example embodiment of the invention. ONT simulator 100 includes an ONT 102 electrically coupled to a simulator host 104 that hosts an ONT/Optical network termination Management and Control Interface (ONT/OMCI) simulation utility 106. The ONT 102 includes a Wave Division Multiplexer/demultiplexer (WDM) 108 optically coupled to OLT 110 at one or more wavelengths as illustrated by optical signals 112a, 112b and 112c, each at a different wavelength. The WDM 108 receives optical signals 112a at a first wavelength from the OLT 110 and guides optical signals 112a to a first optical receiver 114. The first optical receiver 114 converts optical signals 112a into electrical signals 116a. Electrical signals 116a are then transmitted by the first receiver 114 to a communications port 118 via controller 120. Electrical signals 116a are then transmitted by the ONT 102 to the simulator host 104 via the communications port 118 under the control of controller 120.

A field-deployable ONT typically receives digital data at one optical wavelength and video data at another optical wavelength. The ONT 100 may also optionally include, as indicated by dashed lines, video reception capabilities. The optional video reception capabilities include the WMD 108 optionally receiving optical signals 112b from OLT 110 at a second wavelength. The WDM 108 routes optical signals 112b to a second receiver 122. The second receiver 122 converts optical signals 112b to electrical signals 116b.

Electrical signals 116b are then transmitted by the second receiver 122 to a video port 119 via controller 120. Electrical signals 116b are then transmitted by the ONT 102 to the simulator host 104 via the video port 119 under the control of controller 120.

The ONT 102 can also receive transmissions from the simulator host 104. To do so, the controller 120 receives electrical signals 116c via communication port 118 from the simulator host 104 and transmits electrical signals 116c to an optical transmitter 124. The transmitter 124 converts electrical signals 116c into optical signals 112c at a third wavelength. Optical signals 112c are transmitted to the WDM 108 and guided by the WDM 108 to the OLT 110.

The ONT 102 lacks the usual control logic associated with a field-deployable ONT. Instead, the ONT 102 is coupled via communications port 118 to the simulator host 104 hosting the ONT/OMCI simulation utility 106. The ONT 102 sends all Optical network termination Management and Control Interface (OMCI) traffic to the communication port 118 as the ONT 102 is only used for ensuring that an OMCI provisioning path is fully operational between the OLT 110 and the ONT 102. Therefore, the ONT 102 simply forwards the OMCI channel messages from the OLT 110 to the simulator host 104 via the communications port 118.

The ONT/OMCI simulation utility 106 monitors communications received from the communications port 118 and performs all of the functions that would normally be performed by a software package that a field-deployable ONT runs. That is, the ONT/OMCI simulation utility 106 is in a library format that responds to the same types of low-level Application Programming Interface (API) calls as a field deployable ONT would itself. A detailed description of the operations of an ONT is found in ITU-T Recommendation G.983.1 (2005): Broadband optical access systems based on Passive Optical Networks (PON), ITU-T Recommendation G.983.2 (2005): ONT management and control interface specification for B-PON and ITU-T Recommendation G.984.4 (2008): “Gigabit-capable Passive Optical Networks (G PON): ONT management and control interface specification, all by International Telecommunication Union, the contents of each of which are hereby incorporated by reference as if fully stated herein.

The ONT simulator 100 does not provide for any actual services being run end-to-end in the system. Therefore, the ONT simulator 100 is primarily useful in interoperability testing where multiple vendors are initially trying to make their product compatible from an OMCI perspective, which includes the capabilities required for operation under the ISO Telecommunications Management Network model and framework for network management, known as Fault, Configuration, Accounting, Performance, and Security (FCAPS), such as providing for firmware/software upgrades, Performance Monitoring (PM), alarms, etc.

Furthermore, the ONT/OMCI simulator utility 106 can be enhanced to support further testing of multiple scenarios on the ONT simulator 100, including generating alarms, increasing PM counters, supporting different attributes, etc. by transmitting test signals from the OLT 110 to the ONT/OMCI simulation utility 106 via the ONT simulator 100. In addition, the ONT/OMCI simulation utility 106 can transmit test signals to the OLT 110 via the ONT simulator 100. The ONT simulator 100 also provides the ability to generate reports of the OMCI trace between the ONT 102 and the OLT 110. In addition, the ONT/OMCI simulation utility 106 is also able to receive downloads via an OMCI upgrade path.

All these capabilities enable operator to trouble shoot an OLT's and ONT's basic functions without the need to support real-world traffic or the need for expensive equipment that would typically be needed by multiple test groups in order to generate specific network conditions by ONTs under going testing.

In one example embodiment of the invention, the simulator host 104 is a Personal Computer (PC) having a Linux operating system. In this embodiment, the ONT/OMCI simulation utility 106 is a Linux based utility.

In another example embodiment of the invention, the communication port 118 is adapted for communications using the Ethernet protocol. Other example embodiments of the invention may use other communication protocols such as USB, etc. as practicing the invention is not dependent on the specific communication protocol used.

In another example embodiment of the invention, the ONT/OMCI simulation utility 106 includes an emulator for emulating a processor as used in a field-deployable ONT. In this way, the ONT/OMCI simulation utility 106 can utilize the exact same executables used by a field deployable ONT.

In another example embodiment of the invention, optical signals 112a have a wavelength of 1490 nm, optical signals 112b have a wavelength of 1550 nm, and optical signals 112c have a wavelength of 1310 nm.

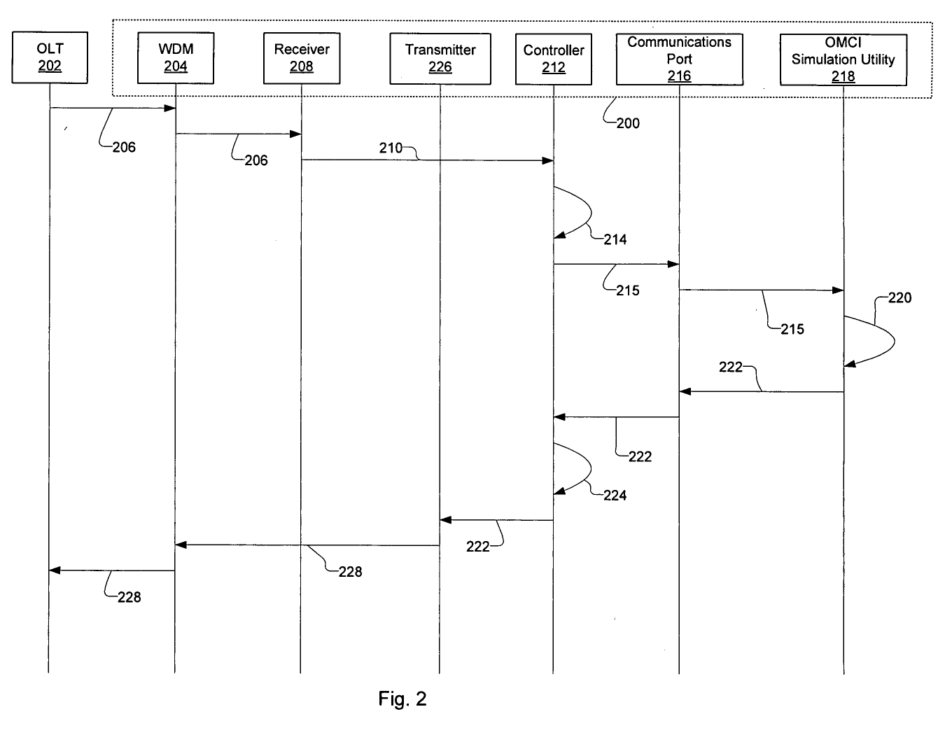

Having described an ONT simulator 100, the operations of the ONT simulator 100 will now be described in reference to FIG. 2. FIG. 2 is a sequence diagram of communications between an ONT simulator 200, such as ONT simulator 100 of FIG. 1, and an OLT 202, such as OLT 110 of FIG. 1, in accordance with an example embodiment of the invention. The ONT simulator 200 includes a WDM 204 that receives optical signals 206 from the OLT 202. The WDM 204 guides the optical signals 206 to an optical receiver 208. The optical receiver 208 uses the optical signals 206 to generate electrical signals 210 that are transmitted to a controller 212. The controller 212 processes (214) the electrical signals 210 to determine if the electrical signals 210 contain ONT/OMCI traffic 215 intended for an ONT/OMCI. If so, the controller forwards the ONT/OMCI traffic 215 via a communications port 216 to an ONT/OMCI simulation utility 218. The ONT/OMCI simulation utility 218 processes (220) the ONT/OMCI traffic 215 as if the ONT/OMCI simulation utility 218 was in a field deployed ONT.

ONT/OMCI simulation utility 218 can also generate outgoing traffic 222 for transmission to the OLT 202. The ONT/OMCI simulation utility 218 transmits the outgoing traffic 222 to the controller 212 via the communications port 216. The controller 212 determines (224) that the outgoing traffic 222 is intended for the OLT 202 and sends the outgoing traffic 222 to an optical transmitter 226. The optical transmitter 226 receives the outgoing traffic 222 as electrical signals and generates optical signals 228 from the outgoing traffic 222. Optical signals 228 are then transmitted to the WDM 204 which guides optical signals 228 to the OLT 202.

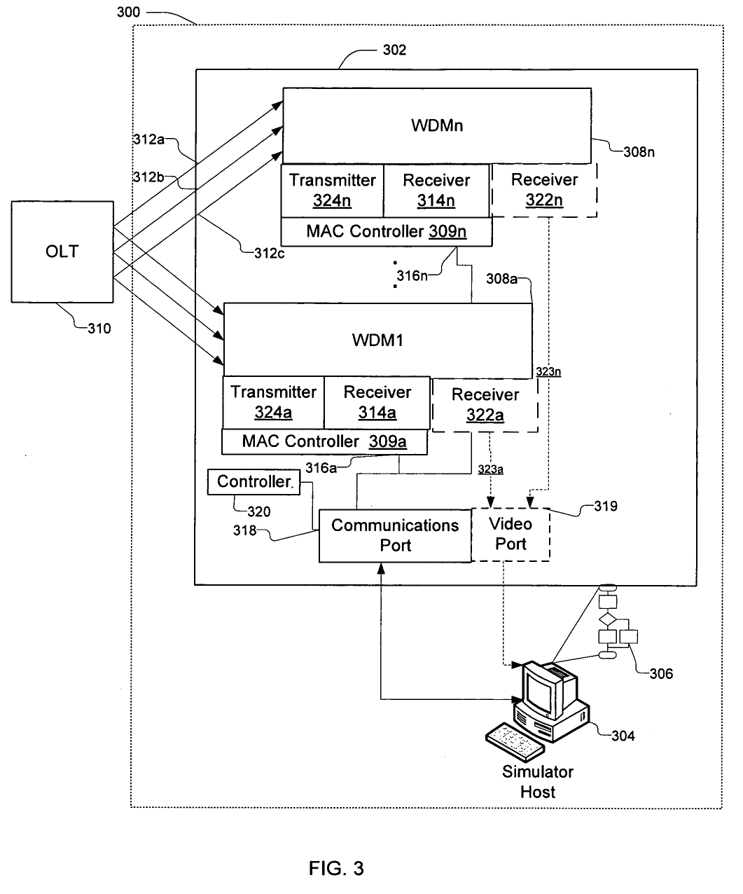

Having described an ONT simulator in FIG. 1 and the operations of an ONT simulator in FIG. 2, a multi-ONT simulator will now be described with reference to FIG. 3. FIG. 3 is a block diagram of a multi-ONT simulator 300 coupled to an OLT 310 in accordance with an example embodiment of the invention. Multi-ONT 302 includes all of the features of the ONT 102 of FIG. 1, but the multi-ONT 302 can behave like multiple field-deployable ONTs.

Multi-ONT simulator 300 includes a multi-ONT 302 electrically coupled to a simulator host 304 that hosts a multi-ONT/OMCI simulation utility 306. The multi-ONT 302 includes multiple WDMs, such as WDM 308a to WDM 308n, optically coupled to OLT 310 at one or more wavelengths. Each of the WDMs 308a to 308n, has an associated Media Access Control (MAC) controller, such as MAC controllers 309a to 309n, respectively. The MACs 309a to 309n provide the capability for each of the WDMs 308a to 308n, to be addressed individually. This enables the multi-ONT 302 to behave as more than one field-deployable ONT when processing optical signals received from the OLT 310 and when receiving electrical signals from the simulator host 304.

The operation of a single WDM and associated MAC controller will now be described in reference to WDM 308a and MAC controller 309a, it being understood that each WDM and associated MAC controller of multi-ONT 302 operates in substantially the same way. In operation, the WDM 308a receives optical signals 312a at a first wavelength from the OLT 310 and guides the optical signals 312a to an optical receiver 314a operable at the first wavelength. The optical receiver 314a converts the optical signals 312a into electrical signals for use by the MAC controller 309a. The converted electrical signals include MAC address information, or other address information in another address scheme such as an IPaddr, VLAN ID, GEM port address, etc., that the MAC controller 309a uses to determine if data encoded in the optical signals 312a and corresponding converted electrical signals are intended for the WDM 308a. Electrical signals 316a are then transmitted by the MAC controller 309a to a communications port 318 via controller 320. Electrical signals 316a are then transmitted by the multi-ONT 302 to the simulator host 304 via communications port 318 under the control of controller 320.

As discussed above in reference to ONT 102 of FIG. 1, the WMD 308a may also receive optional video optical signals 312b at a second wavelength from OLT 310. If so, the WMD 308a guides optical signals 312b to an optical receiver operable at the second wavelength, such as optical receiver 322a. The optical receiver 322a converts optical signals 312b into electrical signals 323a. Electrical signals 323a are then transmitted by the optical receiver 322a to a video port 319 via controller 320. Electrical signals 323a are then transmitted by the multi-ONT 302 to the simulator host 304 via the video port 319 under the control of the controller 320.

The controller 320 also receives electrical signals from the simulator host 304 via communication port 318. The controller 320 then sends the electrical signals to the MAC controller 309a. The electrical signals include MAC address data that the MAC controller 309a uses to determine if the electrical signals are addressed to the MAC controller 309a. If so, the MAC controller 309a uses optical transmitter 324a to convert the electrical signals into optical signals 312c at a third wavelength. Optical signals 312c are then transmitted to the WDM 308a by the optical transmitter 324a and guided by the WDM 308a to the OLT 310.

As can be appreciated from the description of the multi-ONT 302 and the ONT 102 of FIG. 1, the multi-ONT 302 is functionally similar to the ONT 102 but the multi-ONT 302 can behave like multiple field-deployable ONTs. Therefore, the multi-ONT 302 combined with an ONT/OMCI simulation utility 306 has all of the functionality of ONT 102 and is capable of providing additional testing of functionality by transmitting test optical signals from the OLT 310 to the ONT/OMCI simulation utility 306 via the multi-ONT simulator 300. In addition, the ONT/OMCI simulation utility 306 can transmit test electrical signals to the OLT 310 via the multi-ONT simulator 300. Specifically, the multi-ONT 302 provides for a single device having multiple Passive Optical Network (PON) interfaces that connect to a single OLT PON. Therefore, each PON interface on the device represents a single logical or virtual ONT. Each single logical or virtual ONT terminates that OMCI's channels from each PON interface and forwards them via the single communications port 318 to the ONT/OMCI simulation utility 306.

In another example embodiment of the invention, separate communications ports are provided for each of the logical or virtual ONTs.

In another example embodiment of the invention, the ONT/OMCI simulation utility 306 can accommodate simulation of an arbitrary number of ONTs with each ONT being of different type or from different manufacturers, and each running that manufacturer's own ONT control software.

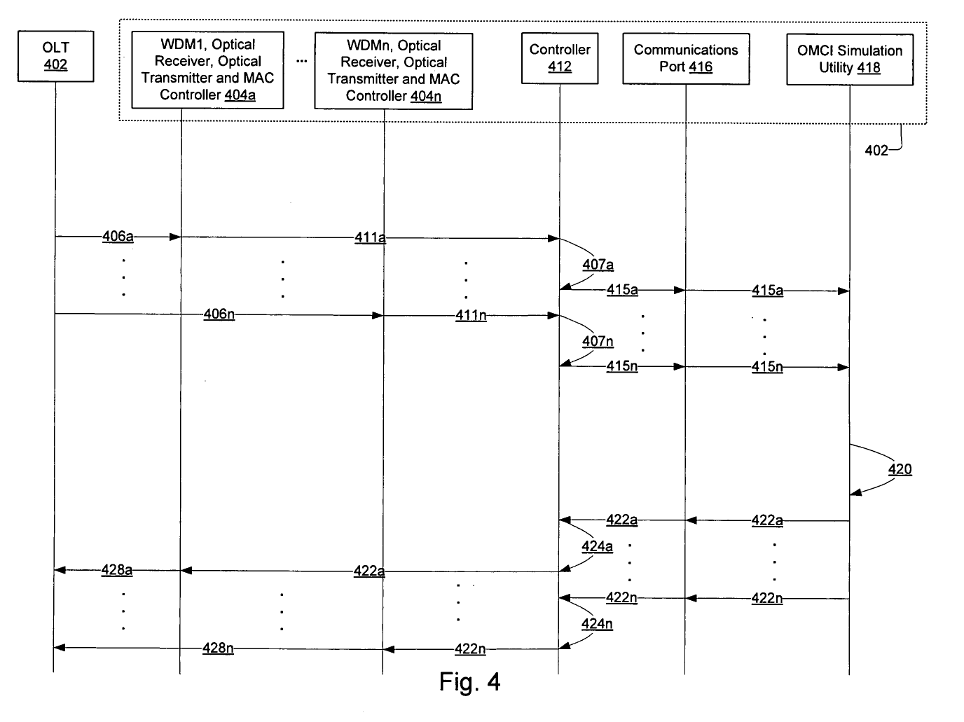

Having described the configuration of a multi-ONT in accordance with an example embodiment of the invention, the operations of a multi-ONT will now be described in reference to FIG. 4. FIG. 4 is a sequence diagram of communications between an OLT 400 and a multi-ONT simulator 402, such as multi-ONT simulator 300 of FIG. 3, in accordance with an example embodiment of the invention. The multi-ONT simulator 402 includes multiple WDMs each associated with a respective optical receiver, optical transmitter and MAC controller, such as WDMs 404a to 404n, that receive optical signals, such as optical signals 406a to 406n, from the OLT 402. The WDMs 404a to 404n guide the optical signals to their respective optical receivers. The optical receivers use the optical signals to generate electrical signals that are transmitted to their respective MAC controllers. The respective MAC controllers then determine if the electrical signals contain address information indicating that the optical signals 406a to 406n were addressed to the MAC controllers' respective ONTs. If so, the MAC controllers transmit electrical signals 411a to 411n to a controller 412. The controller 412 processes (407a to 407n) the electrical signals 411a to 411n to determine if the electrical signals 411a to 411n contain ONT/OMCI traffic 415a to 415n intended for an ONT/OMCI. If so, the controller 412 forwards the ONT/OMCI traffic 415a to 415n via a communications port 416 to an ONT/OMCI simulation utility 418. The ONT/OMCI simulation utility 418 processes (420) the ONT/OMCI traffic 415a to 415n as if the ONT/OMCI simulation utility 418 was in a field deployed ONT.

ONT/OMCI simulation utility 418 can also generate outgoing traffic for transmission to the OLT 402. In doing so, the ONT/OMCI simulation utility 418 transmits electrical signals 422a to 422n containing the outgoing traffic to the controller 412 via the communications port 416. The controller 412 determines (424a to 424n) that the electrical signals 422a to 422n contain outgoing traffic intended for the OLT 402 and sends the electrical signals 422a to 422n to the MAC controllers associated with the WDMs 404a to 404n. The MAC controllers analyze the outgoing traffic contained in the electrical signals 422a to 422n to determine if the outgoing traffic includes address information designating the MAC controllers' respective WDMs 404a to 404n. If so, the electrical signals 422a to 422n are used by the WDMs' 404a to 404n respective optical transmitters to generate optical signals 428a to 428n that are routed by the WDMs 404a to 404n to the OLT 402.

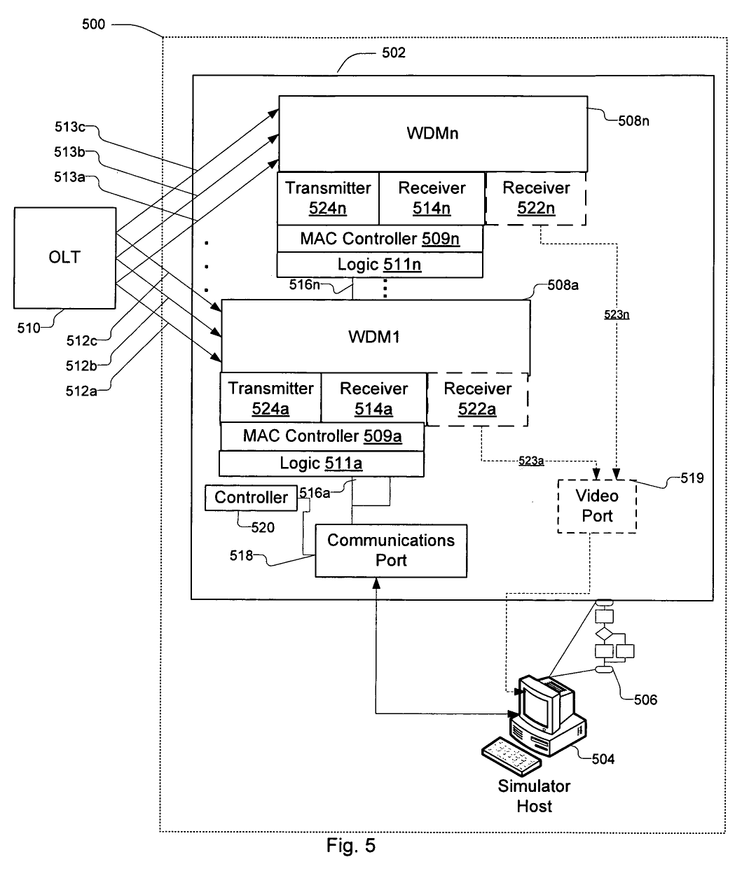

Having described a multi-ONT simulator in FIG. 3 and the operations of a multi-ONT simulator in FIG. 4, a multi-ONT simulator having additional functions will now be described with reference to FIG. 5. FIG. 5 is a block diagram of a multi-ONT simulator 500 having additional functions, coupled to an OLT 510, in accordance with an example embodiment of the invention. The multi-ONT 502 provides all the capabilities as the multi-ONT 302 of FIG. 3, except, the multi-ONT 502 provides an enhanced ONT with replicated optics and MAC components that can emulate multiple ONTs simultaneously.

Multi-ONT simulator 500 includes a multi-ONT 502 electrically coupled to a simulator host 504 that hosts a multi-ONT/OMCI simulation utility 506. Multi-ONT 502 includes multiple WDMs, such as WDM 508a to WDM 508n, optically coupled to an OLT 510 at one or more wavelengths.

Each of the WDMs 508a to 508n, has an associated MAC controller, such as MAC controllers 509a to 509n, respectively. The MAC controllers 509a to 509n provide the capability for each of the WDMs 508a to 508n, to be addressed individually. In addition, each MAC controller includes additional control logic 511a to 511n. The additional control logic enables the MAC controllers 509a to 509n to perform additional functions that are not performed by the multi-ONT 302 of FIG. 3.

The operation of a single WDM and associated MAC controller with additional control logic will now be described in reference to WDM 508a and MAC controller 509a, it being understood that each WDM and associated MAC controller of multi-ONT 502 operates in substantially the same way. In operation, the WDM 508a receives optical signals 512a at a first wavelength from the OLT 510 and guides the optical signals 512a to an optical receiver 514a operable at the first wavelength. The optical receiver 514a converts the optical signals 512a into electrical signals for use by the MAC controller 509a. The converted electrical signals include MAC address information that the MAC controller 509a uses to determine if data encoded in the optical signals 512a and corresponding converted electrical signals is intended for the WDM 508a. Electrical signals 516a are then transmitted by the MAC controller 509a to a communications port 518 via controller 520. Electrical signals 516a are then transmitted by the multi-ONT 502 to the simulator host 504 via the communications port 518 under the control of controller 520.

As discussed above in reference to ONT 302 of FIG. 3, the WMD 508a may also receive optional video optical signals 512b at a second wavelength from OLT 510. If so, the WMD 508a guides optical signals 512b to an optical receiver operable at the second wavelength, such as optical receiver 522a. The optical receiver 522a converts optical signals 512b into electrical signals 523a. Electrical signals 523a are then transmitted by the optical receiver 522a to a video port 519. Electrical signals 523a are then transmitted by the multi-ONT 502 to the simulator host 504 via the video port 519 under the control of the controller 520.

The controller 520 also receives electrical signals from the simulator host 504 via communication port 518. The controller 520 then sends the electrical signals to the MAC controller 509a. The electrical signals include MAC address data that the MAC controller 509a uses to determine if the electrical signals are addressed to the MAC controller 509a. If so, the MAC controller 509a uses optical transmitter 524a to convert the electrical signals into optical signals 512c at a third wavelength. Optical signals 512c are then transmitted to the WDM 508a by the optical transmitter 524a and guided by the WDM 508a to the OLT 510.

In another example embodiment of the invention, the multi-ONT includes additional logic 511a to 511n that provide the multi-ONT with additional functionality, such as supporting multiple serial numbers and passwords that are assigned to multiple internal ONT IDs.

In another example embodiment of the invention, the multi-ONT responds to ranging requests for multiple ONT types.

In another example embodiment of the invention, the multi-ONT enables ranging with an OLT/PON line card. This includes ranging any of the individual ONTs at any time with the OLT.

In another example embodiment of the invention, the multi-ONT responds to separate Traffic-CONTainer (T-CONT) Grants.

In another example embodiment of the invention, the multi-ONT enables updating and churning of encryption keys separately for each individual ONT and enables or disables encryption for the ONTs selectively. A more detailed discussion of ranging, T-CONT grants and encryption key churning is found in ITU-T Recommendation G.984.3 (2008), “Gigabit-capable Passive Optical Networks (G-PON): Transmission convergence layer specification,” International Telecommunication Union, the contents of which are incorporated by reference as if stated in full herein.

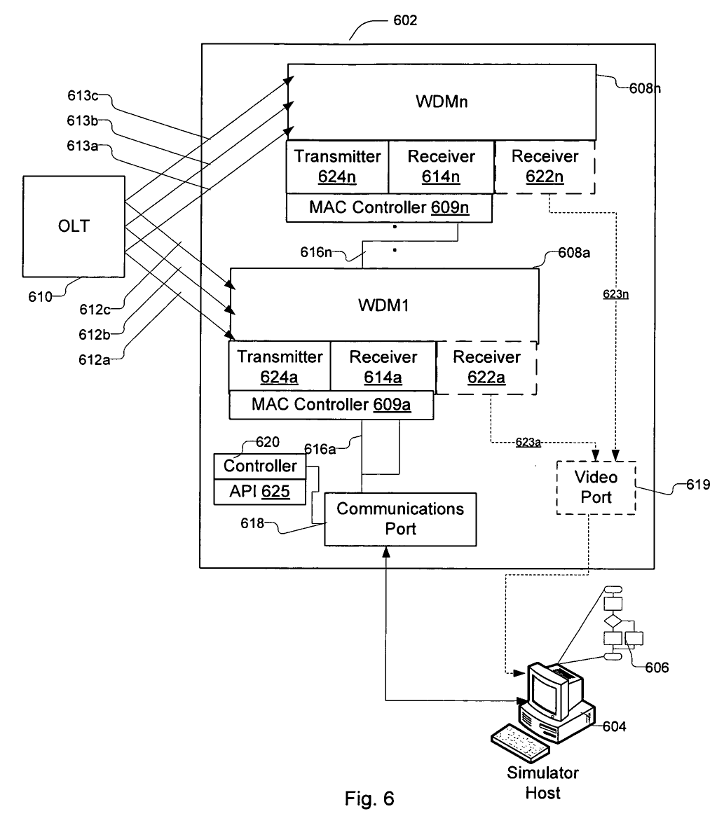

Having described a multi-ONT simulator in FIG. 3 and the operations of a multi-ONT simulator in FIG. 4, a multi-ONT simulator having an Application Programming Interface (API) will now be described with reference to FIG. 6. FIG. 6 is a block diagram of a multi-ONT simulator 600 having an API, coupled to OLT 610, in accordance with an example embodiment of the invention. The multi-ONT 602 provides all the capabilities as the multi-ONT 302 of FIG. 3 or the multi-ONT 502 with additional features of FIG. 5 except the multi-ONT 602 behavior is more sophisticated and requires additional communications between the multi-ONT 602 and the simulator host 604.

The multi-ONT simulator 600 includes a multi-ONT 602 electrically coupled to a simulator host 604 that hosts a multi-ONT/OMCI simulation utility 606. The multi-ONT 602 includes multiple WDMs, such as WDM 608a to WDM 608n, optically coupled to an OLT 610 at one or more wavelengths.

Each of the WDMs 608a to 608n, has an associated MAC controller, such as MAC controllers 609a to 609n, respectively. The MAC controllers 609a to 609n provide the capability for each of the WDMs 608a to 608n, to be addressed individually.

The operation of a single WDM and associated MAC controller will now be described in reference to WDM 608a and MAC controller 609a, it being understood that each WDM and associated MAC controller of multi-ONT 602 operates in substantially the same way. In operation, the WDM 608a receives optical signals 612a at a first wavelength from the OLT 610 and guides the optical signals 612a to an optical receiver 614a operable at the first wavelength. The optical receiver 614a converts the optical signals 612a into electrical signals for use by the MAC controller 609a. The converted electrical signals include MAC address information that the MAC controller 609a uses to determine if data encoded in the optical signals 612a and corresponding converted electrical signals is intended for the WDM 608a. Electrical signals 616a are then transmitted by the MAC controller 609a to a communications port 618 via controller 620. Electrical signals 616a are then transmitted by the multi-ONT 602 to the simulator host 604 via a communications port 618 under the control of controller 620.

As discussed above in reference to ONT 302 of FIG. 3, the WMD 608a may also receive optional video optical signals 612b at a second wavelength from OLT 610. If so, the WMD 608a guides optical signals 612b to an optical receiver operable at the second wavelength, such as optical receiver 622a. The optical receiver 622a converts optical signals 612b into electrical signals 623a. Electrical signals 623a are then transmitted by the optical receiver 622a to a video port 619. Electrical signals 623a are then transmitted by the multi-ONT 602 to the simulator host 604 via the video port 619 under the control of the controller 620.

The controller 620 also receives electrical signals from the simulator host 604 via communication port 618. The controller 620 then sends the electrical signals to the MAC controller 609a. The electrical signals include MAC address data that the MAC controller 609a uses to determine if the electrical signals are addressed to the MAC controller 609a. If so, the MAC controller 609a uses optical transmitter 624a to convert electrical signals into optical signals 612c at a third wavelength. Optical signals 612c are then transmitted to the WDM 608 by the optical transmitter 624a and guided by the WDM 608a to the OLT 610.

The multi-ONT 602 enables the simulator host 604 to perform the OMCI operations as described before, but now provides an API interface 625 that a higher level software application (not shown) can use to program ONT services, such as voice, video, and data. APIs would also be used for PM, status and alarm gathering.

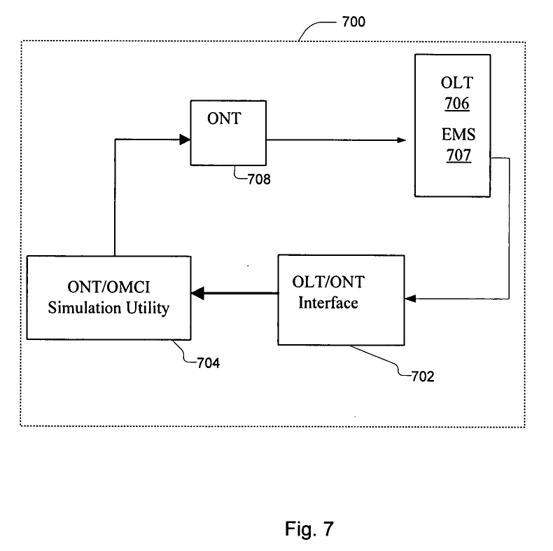

FIG. 7 is a collaboration diagram of an end-to-end ONT simulator with a Graphical User Interface (GUI) in accordance with an example embodiment of the invention. In an end-to-end ONT simulator 700, an ONT/OLT interface 702 is operably connected to an ONT/OMCI simulation utility 704, such as ONT/OMCI simulation utility 106 of FIG. 1 or one of the previously described multi-ONT/OMCI simulation utilities 306, 506 or 606 as described in FIG. 3, FIG. 5 or FIG. 6, respectively, and an OLT 706 having an Element Management System (EMS) 707, such as OLTs 110, 310, 510 and 610 as described in FIG. 1, FIG. 3, FIG. 5 and FIG. 6, respectively. The ONT/OLT interface 702 between the ONT/OMCI simulation utility 704 and the OLT 706 provides an end-to-end test setup that enables an automated setup, where the ONT/OLT interface 702 can automatically generate alarms and other features from an ONT 708's perspective, then the same ONT/OLT interface 702 can communicate with the EMS 707 (via Transaction Language 1 (TL1) or some other protocol) and determine if the alarms have been generated at the EMS 707. The same behavior can occur for all features, whether the ONT/OLT interface 702 has to query specific OMCI values such as status, performance monitoring or configured values. For example, the ONT/OLT interface 702 would communicate with the ONT/OMCI simulation utility 704 and tell the ONT/OMCI simulation utility 704 to generate specific errors or random behaviors, then the ONT/OMCI simulation utility 704 would query the EMS 707 via TL1 (or similar protocol) to ensure that the specific error and random behaviors have been generated properly and collected/display appropriately by the EMS 707.

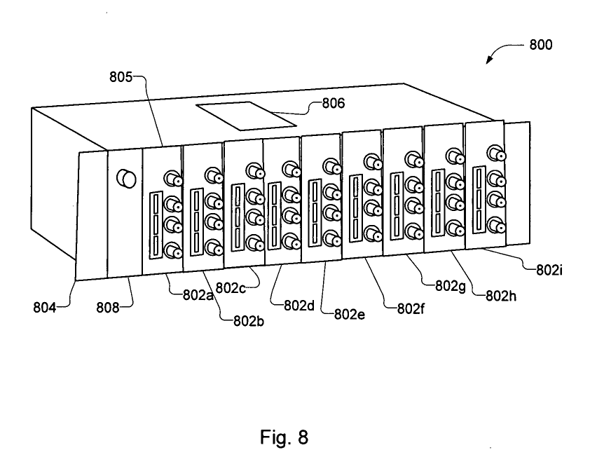

FIG. 8 is a perspective view of a multi-ONT system 800 composed of individual ONTs, such as ONTs 802a, 802b, 802c, 802d, 802e, 802f, 802g, 802h and 802i packaged in a rack mount 804 in accordance with an example embodiment of the invention. This is a single mechanical package that provides the ability to store ONTs in a small rack that also contains patch panels, such as patch panel 805 of ONT 802a, for each ONT's optical interfaces, data interfaces, video interfaces, and Plain Old Telephone Services (POTS) interfaces. The ONTs 802a, 802b, 802c, 802d, 802e, 802f, 802g, 802h and 802i themselves need not be in separate enclosures. Instead, operational ONT PCBs are mounted beside or stacked accordingly as to not provide any environmental cross-effects or electrical interference. The rack 804 itself may provide for a cooling fan 806 and a common power supply 808. Video, Optical Fiber, Ethernet Cat5, twisted pair can all be routed to patch panels on the unit as needed (for fully operational ONTs).

In another example embodiment of the invention, an individual power supply and battery backup are supplied for each individual ONT.

In another example embodiment of the invention, the individual ONTs forward OMCI messages directly to an external simulator and no actual data/voice/video are provided, and there is no need for battery backup, or separate power supplies because the ONT simulator will have be able to generate these without querying a battery.

In another example embodiment of the invention, a simulator host hosts an ONT/OMCI simulation utility (not shown) similar in function to the ONT/OMCI simulation utilities previously described. The ONT/OMCI simulation utility is used to simulate certain events such as data flows like counter increments, erroneous conditions indicated by generated failures alarms, Threshold Crossing Alerts (TCAs), etc. in order to perform end-to-end testing of the individual ONTs.

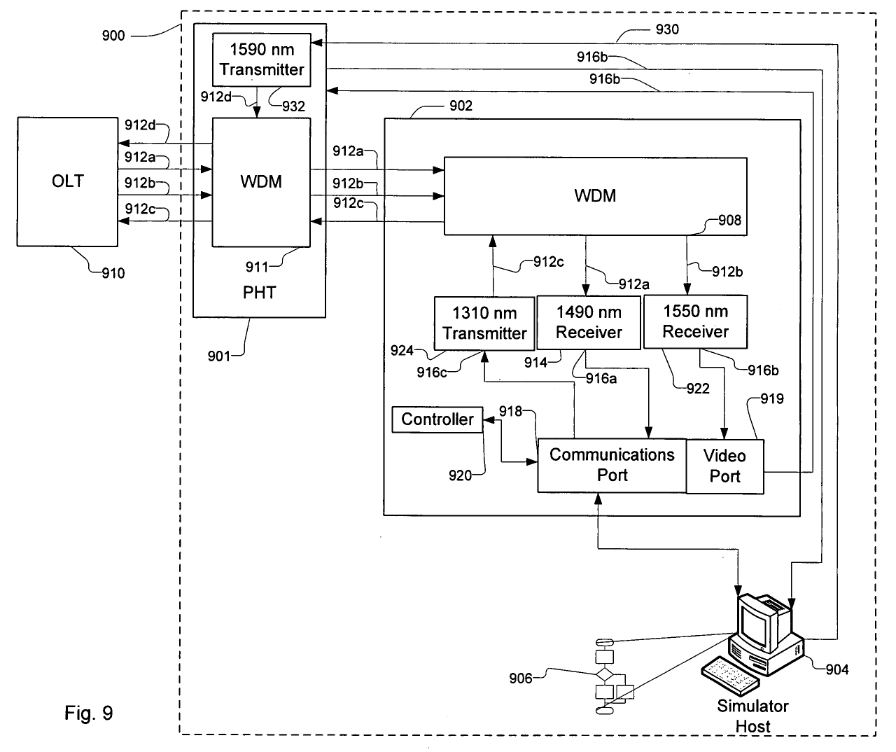

FIG. 9 is a block diagram of an ONT simulator 900 including an additional device that adds additional features to the ONT simulator 900 in accordance with an example embodiment of the invention. As an example of an additional feature, a field deployed ONT may not have a Radio Frequency (RF) back channel that allows a RF video Set Top Box (RF STB) coupled to the field deployed ONT to communicate to a cable head that is supplying video signals to the RF STB via the field deployed ONT. By adding an additional device to the field deployed ONT, such a feature can be easily added to the field deployed ONT. However, as the additional device is deployed with the field deployed ONT, it becomes desirable to test the additional device in the same manner as a field deployable ONT is tested. By using ONT simulator 900 including an additional device, such as PON Home Transceiver (PHT) 901, the operation of the additional device may be tested as well.

ONT simulator 900 includes an ONT 902 electrically coupled to a simulator host 904 that hosts an ONT/Optical network termination Management and Control Interface (ONT/OMCI) simulation utility 906. ONT 902 includes an additional device, PHT 901, that couples ONT 902 to an OLT 910. PHT 901 is optically coupled to OLT 910 by WDM 911 at one or more wavelengths as illustrated by optical signals 912a, 912b, 912c and 912d, each at a different wavelength. WDM 911 of PHT 901 passes optical signals 912a and 912b through to Wave Division Multiplexer/demultiplexer (WDM) 908 of ONT 902. WDM 908 receives optical signals 912a at a first wavelength from OLT 910 via the WDM 911 and guides optical signals 912a to a first optical receiver 914. The first optical receiver 914 converts optical signals 912a into electrical signals 916a. Electrical signals 916a are then transmitted by the first receiver 914 to a communications port 918 via controller 920. Electrical signals 916a are then transmitted by the ONT 902 to the simulator host 904 via the communications port 918 under the control of controller 920.

ONT 900 also includes video reception capabilities. The video reception capabilities include the WMD 908 receiving optical signals 912b including a video signal from WDM 911 via PHT 901 at a second wavelength. WDM 908 routes optical signals 912b to a second receiver 922. The second receiver 922 converts optical signals 912b to electrical signals 916b including the video signal.

Electrical signals 916b are then transmitted by the second receiver 922 to a video port 919 via controller 920. Electrical signals 916b are then transmitted to PHT 901. PHT 901 receives the electrical signals and retransmits them to the simulator host 904 as if the simulator host 904 were an RF STB.

ONT 902 can also receive transmissions from the simulator host 904. To do so, the controller 920 receives electrical signals 916c via communication port 918 from the simulator host 904 and transmits electrical signals 916c to an optical transmitter 924. The transmitter 924 converts electrical signals 916c into optical signals 912c at a third wavelength. Optical signals 912c are transmitted to the WDM 908 and guided by the WDM 908 to OLT 910 via WDM 911 of PHT 901.

In addition, PHT 901 can also receive electrical signal transmissions from the simulator host 904 for retransmission as optical signals to OLT 910, thus simulating a back channel for a RF STB to communicate with a cable head. To do so, PHT 901 receives, at second transmitter 932, electrical signals 930 from the simulator host 904. Second transmitter 932 converts electrical signals 930 into optical signals 912d at a fourth wavelength. Optical signals 912d then are transmitted to WDM 911 and guided by WDM 911 to OLT 910.

In operation, ONT simulator 900 can be utilized in the same manner as ONT simulator 100 of FIG. 1. In addition, in differing example embodiments of the invention, ONT simulator 900 can be given additional features and operate in a similar manner as multi-ONT simulator 300 of FIG. 3, multi-ONT simulator 500 of FIG. 5 or multi-ONT 602 of FIG. 6.

In another example embodiment of the invention, optical signals 912a have a wavelength of 1490 nm, optical signals 912b have a wavelength of 1550 nm, optical signals 912c have a wavelength of 1310 nm and optical signals 912d have a wavelength of 1590 nm.

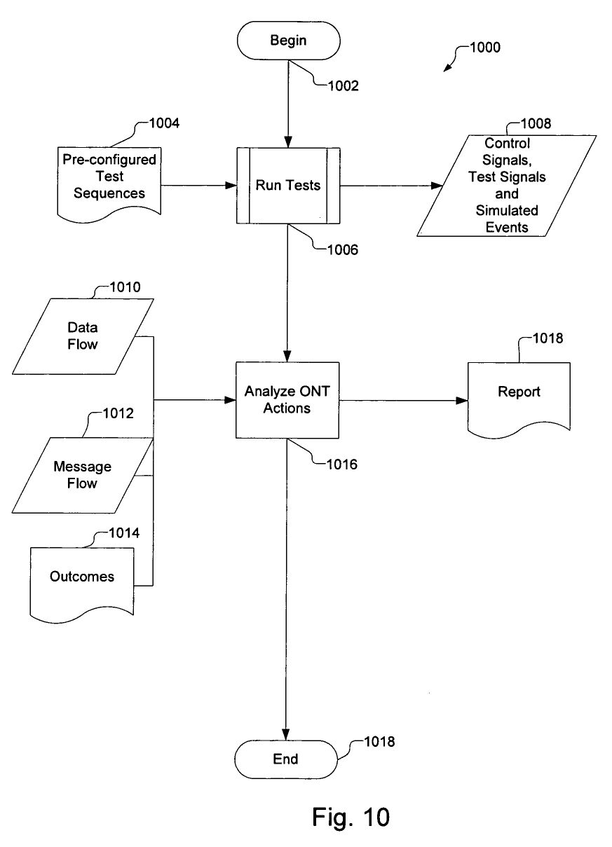

FIG. 10 is a process flow diagram of an automated test sequence and report generation process 1000 as executed by an ONT simulator in accordance with an example embodiment of the invention. The process begins (1002) by reading a set of pre-configured test sequences 1004. The set of pre-configured test sequences 1004 are used by an ONT/OMCI simulation utility, such as any of the ONT/OMCI simulation utilities as previously described, to run tests (1006) by generating control signals, test signals and simulated events 1008 for operating an ONT simulator, such as any of the ONT simulators previously described.

During the test, the automated test sequence and report generation process 1000 monitors and records the actions of the ONT simulator by monitoring the ONT simulator's actions in response to the control signals, test signals and simulated events 1008. To do so, the automated test sequence and report generation process 1000 monitors data flow 1010, message flow 1012 and outcomes 1014 of the ONT simulator such as PM, alarms, operational statistics, errors, etc. The automated test sequence and report generation process 1000 then analyzes the ONT actions (1016) to generate a report 1018. The report can then be used to improve the ONT simulator, the actual ONT interfaces, system performance, system efficiency and other operational parameters. The automated test sequence and report generation process 1000 then ends (1018).

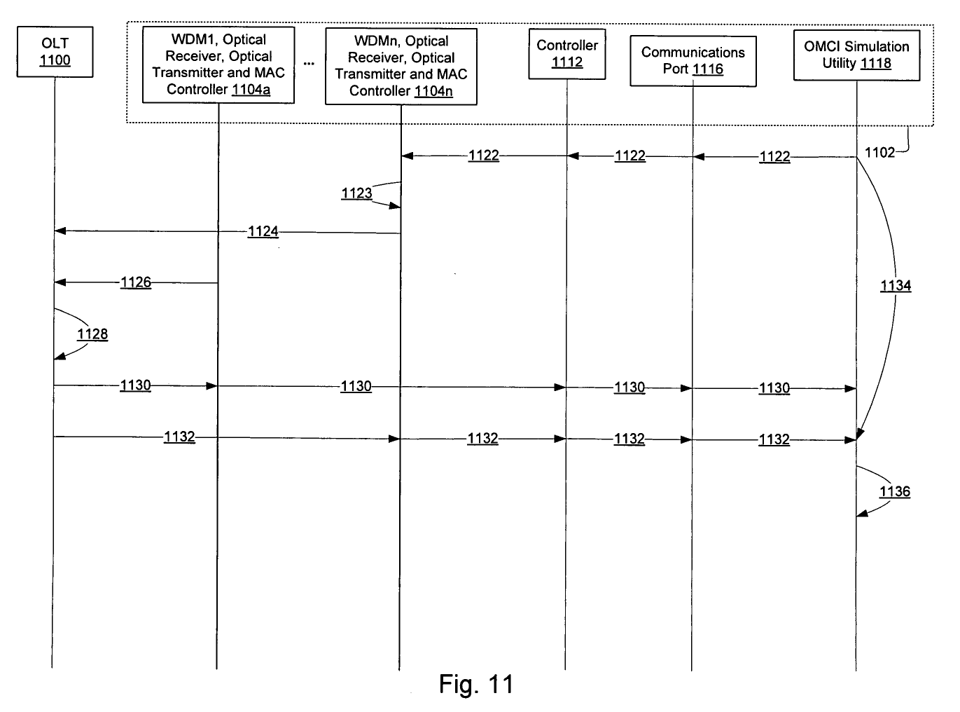

FIG. 11 illustrates an example of a pre-configured test that may be run by the automated test sequence and report generation process 1000 of FIG. 10. Specifically, FIG. 11 is a sequence diagram of communications between an OLT 1100 and a multi-ONT simulator 1102 simulating a rogue ONT in accordance with an example embodiment of the invention. A rogue ONT is an ONT which interferes with the operations of other ONTs, such as by interfering with PON timeslots associated with the other ONTS. To perform the simulation of a rogue ONT, OMCI simulation utility 1118 of multi-ONT simulator 1102 takes control of the operations of ONT 1104n by transmitting command signals 1122 to ONT 1104n via communications port 1116 and controller 1112. In response to the control signals, ONT 1104n reconfigures (1123) itself to operate in an erroneous manner, such as by transmitting during the PON time slot of another ONT, such as ONT 1104a.

After reconfiguring itself, ONT 1104n begins transmitting data 1124 erroneously to OLT 1100 in the PON time slot of ONT 1104a. In addition, ONT 1104a also tries to transmit data 1126 to OLT in ONT 1104a's assigned time slot. OLT 1100 detects (1128) the erroneous transmissions by ONT 1104n and transmit ONT shut down signals 1130 and 1132 to ONT 1104a and ONT 1104n, respectively. ONT shutdown signal 1130 is forwarded by ONT 1104a to OMCI simulation utility 1118 via controller 1112 and communication port 1116. In addition, ONT shutdown signal 1132 is forwarded by ONT 1104n to OMCI simulation utility 1118 via controller 1112 and communication port 1116. In the interim between transmission of command signals 1122 and reception of ONT shutdown signals 1130 and 1132, OMCI simulation utility 1118 waits (1134) for ONT shutdown signals 1130 and 1132, keeping track of the elapsed time. After receiving ONT shutdown signals 1130 and 1132, OMCI simulation utility 1118 generates (1136) a report detailing the time it took for OLT 1100 to issue ONT shutdown signals 1130 and 1132.

Software embodiments of the invention may be provided as a computer program product, or software, that may include an article of manufacture on a machine accessible or computer-readable medium (memory) having instructions. The instructions on the machine accessible or computer-readable medium may be used to program a computer system or other electronic device. The computer-readable medium may include, but is not limited to, floppy diskettes, optical disks, CD-ROMs, and magneto-optical disks or other types of media/computer-readable medium suitable for storing or transmitting electronic instructions. The techniques described herein are not limited to any particular software configuration. They may find applicability in any computing or processing environment. The terms “machine accessible medium” or “computer-readable medium” used herein shall include any medium that is capable of storing, encoding, or transmitting a sequence of instructions or data for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and usefulness of the invention, are presented for example purposes only. The architecture of the invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the invention in any way. It is also to be understood that the steps and processes recited in the claims need not be performed in the order presented.

What is claimed is:

1. An Optical Network Terminal (ONT) test system comprising:
an ONT simulator, including at least one Wave Division Multiplexer (WDM) coupled at a first optical wavelength to a first optical receiver and a communication port electrically coupled to the optical receiver; and
a host coupled to the communication port, the host hosting an ONT/Optical network termination Management and Control Interface (ONT/OMCI) simulation utility operably coupled by the communication port to the first optical receiver.

2. The ONT test system of claim 1, the ONT simulator further including an optical transmitter coupled to the WDM at a second wavelength, the optical transmitter further coupled to the ONT/OMCI simulation utility by the communication port.

3. The ONT test system of claim 2, the ONT simulator further including a second optical receiver coupled at a third optical wavelength to the WDM, the second optical receiver electrically coupled to the communications port.

4. The ONT test system of claim 2, the ONT simulator further including a second optical transmitter coupled at a fourth optical wavelength to the WDM, the second optical transmitter electrically coupled to the host.

5. The ONT test system of claim 1, further comprising an ONT/Optical Line Termination (OLT) interface coupled between the ONT simulator and an OLT.

6. The ONT test system of claim 1, wherein the at least one WDM comprises a plurality of WDMs, each WDM associated with a respective Media Access Control (MAC) controller, each respective MAC controller operably coupled to the ONT/OMCI simulation utility by the communication port.

7. The ONT test system of claim 6, the ONT simulator further comprising a plurality of optical transmitters, each of the optical transmitters coupled to a respective WDM of the plurality of WDMs at a second wavelength.

8. The ONT test system of claim 7, the ONT simulator further comprising a plurality of second optical receivers, each of the second optical receivers coupled to a respective WDM of the plurality of WDMs at a third wavelength.

9. The ONT test system of claim 8, the ONT simulator further comprising a plurality of second optical transmitters, each of the second optical transmitters coupled to a respective WDM of the plurality of WDMs at a fourth wavelength.

10. The ONT test system of claim 6, further comprising an ONT/OLT interface coupled between the ONT simulator and an OLT.

11. A multi-Optical Network Terminal (ONT) system, comprising:
a plurality of individual ONTs in a rack mount; and
a power supply coupled to each individual ONT of the plurality of individual ONTs.

12. The multi-ONT system of claim 11, further comprising an ONT/OLT interface coupled between the ONT simulator and an OLT.

13. A method of testing an Optical Network Terminal (ONT) comprising:
transmitting a first test signal by an Optical Line Termination (OLT) to an ONT simulator utilizing a first wavelength;
receiving the first test signal by the ONT simulator from the OLT using at least one Wave Division Multiplexer (WDM) coupled at the first optical wavelength to a first optical receiver; and
transmitting the first test signal by the ONT simulator to an ONT/Optical network termination Management and Control Interface (ONT/OMCI) simulation utility via a communication port electrically coupled to the optical receiver.

14. The method of testing an ONT of claim 13, wherein the ONT simulator further includes an optical transmitter coupled to the WDM at a second wavelength, the optical transmitter further coupled to the ONT/OMCI simulation utility by the communication port, the method further comprising transmitting a second test signal from the ONT/OMCI simulation utility to the OLT via the ONT simulator utilizing the second wavelength.

15. The method of testing an ONT of claim 14, wherein the ONT simulator further includes a second optical receiver coupled at a third optical wavelength to the WDM, the second optical receiver electrically coupled to the communications port, the method further comprising transmitting a third test signal utilizing the third wavelength from the OLT to the ONT/OMCI simulation utility via the ONT simulator.

16. The method of testing an ONT of claim 15, wherein the ONT simulator further includes a second optical transmitter coupled at a fourth optical wavelength to the WDM, the second optical transmitter electrically coupled to the communications port, the method further comprising transmitting a fourth test signal utilizing the fourth wavelength from the OLT to the ONT/OMCI simulation utility via the ONT simulator.

17. The method of testing an ONT of claim 13, wherein the at least one WDM comprises a plurality of WDMs, each WDM associated with a respective Media Access Control (MAC) controller, each respective MAC controller operably coupled to the ONT/OMCI simulation utility by the communication port, the method further comprising transmitting a plurality of first test signals utilizing the first wavelength from the OLT to the ONT/OMCI simulation utility via the ONT simulator using the plurality of WDMs.

18. The method of testing an ONT of claim 17, wherein the ONT simulator further includes a plurality of optical transmitters, each of the optical transmitters coupled to a respective WDM of the plurality of WDMs at a second wavelength, the method further comprising transmitting a plurality of second test signals from the ONT/OMCI simulation utility to the OLT via the ONT simulator utilizing the second wavelength.

19. The method of testing an ONT of claim 18, wherein the ONT simulator further includes a plurality of second optical receivers, each of the second optical receivers coupled to a respective WDM of the plurality of WDMs at a third wavelength, the method further comprising transmitting a plurality of third test signals utilizing the third wavelength from the OLT to the ONT/OMCI simulation utility via the ONT simulator.

20. The method of testing an ONT of claim 19, wherein the ONT simulator further includes a plurality of second optical transmitters, each of the second optical transmitters coupled to a respective WDM of the plurality of WDMs at a fourth wavelength, the method further comprising transmitting a plurality of fourth test signals utilizing the fourth wavelength from the OLT to the ONT/OMCI simulation utility via the ONT simulator.

21. The method of testing an ONT of claim 13, further comprising:
reading a set of pre-configured test sequences by the ONT/OMCI simulation utility;
generating a plurality of test signals by the ONT/OMCI simulation utility using the pre-configured test sequences, the test signals for operation of the ONT simulator;
monitoring by the ONT/OMCI simulation utility, outcomes of the ONT simulator in response to the test signals; and
generating a report by the ONT/OMCI simulation utility using the outcomes.
